(19) United States
(12) Patent Application Publication
(10) Pub. No.: US 2017/0089331 A1
(43) Pub. Date: Mar. 30, 2017

(54) FLUID REMOVAL FROM A SUMP WITH ELECTRONIC CONTROL AND FLUID TYPE SEPARATION

(71) Applicant: H2O Gone, LLC, Maple Grove, MN (US)

(72) Inventors: Richard Bialick, Eden Prairie, MN (US); Britt Aaseby, Becker, MN (US); David Dubbe, Cologne, MN (US); Paul Schumacher, Loretto, MN (US)

(21) Appl. No.: 15/010,903

(22) Filed: Jan. 29, 2016

Related U.S. Application Data
(60) Provisional application No. 62/110,094, filed on Jan. 30, 2015.

(51) Int. Cl. F04B 49/02; F04D 15/02; B66B 11/00

(52) U.S. Cl. CPC F04B 49/022; B66B 11/0005; F04D 15/0218

(57) ABSTRACT

A fluid removal system for removing fluid from a collection location that includes a collection container, a pump, a pump input tube, a pump output tube and a switching mechanism. The sump at least partially extends below a lower surface of the elevator pit. The plump mounted outside of the elevator pit. The pump input line is operably connected to the sump and the pump. The pump output line is operably connected to the pump. The switching mechanism is mounted outside of the sump and is operably connected to the pump and the sump.

### FIELD OF THE INVENTION

The invention relates generally to a fluid removal system. More particularly, the invention relates to systems for removal of fluids from a pit.

### BACKGROUND OF THE INVENTION

Elevators have gained significant popularity in modern society as the elevators enable persons even with limited physical capabilities to move between the floors in buildings. As elevators enable buildings to be much taller, society has been able to form into more densely populated business and residential configurations.

Since it is often desirable for the elevators to service all of the floors in a particular building, it is necessary for a pit to be formed beneath the elevator that is adapted to receive a lower portion of the elevator that is below the floor of the lowest level.

Depending on the area in which the building is located, water may be present in the ground that is located beneath the building. Because of the position of the elevator pit beneath the ground level, the presence of water surrounding the elevator pit may cause water to leak into the elevator pit. If such water is not removed from the elevator pit, the water may cause degradation of the elevator components that are located in the elevator pit and thereby impact the safe operation of the elevator.

The ground water may exert hydronic pressure on the components of the building and, if not released, may cause damage to the components of the building. Such damage may ultimately render the building uninhabitable.

Fluids, including but not limited to ground water, gasoline, oil, and the like, can accumulate in any low-lying location, such as an elevator sump, a pit, or even a low-lying depression. Such locations may require dry conditions, and the removal of accumulated fluids therefrom.

One technique for removing water from an elevator pit involves placing a pump in the elevator pit. While this option enables water to be removed from the elevator pit, the building/elevator codes in many parts of the country do not permit mechanical devices other than elevator related equipment to be placed in the elevator pit.

One technique that has been utilized to prevent water from entering the elevator shaft is applying a waterproof coating to the walls and floor of the elevator shaft. While this technique may restrict water from entering the elevator shaft, this technique often fails due to hydronic pressure caused by water in the ground surrounding the elevator pit.

Because of the building components that surround the elevator pit, it is often not possible to excavate the area surrounding the elevator pit to install other water removal systems. Additionally, worker protection regulations also would necessitate the length and width of such a hole to be impermissibly large.

### SUMMARY

An embodiment of the invention is directed to a system for removing accumulated fluid from a pit. The removal system may include a collection container, a pump assembly and a fluid level sensor. The collection container may be located in or under the pit. The pump assembly removes fluid from the collection container. The fluid level sensor controls the operation of the pump assembly based upon the level of fluid in the sump.

### BRIEF DESCRIPTION OF THE DRAWINGS

FIG. 1 is a schematic illustration of a prior art water removal system.

FIG. 2 is a side view of an alternative configuration of the pump inlet tube and the pressure sensor tube of the prior art water removal system.

FIG. 3 is a screen shot of an electronic panel according to an embodiment of the present disclosure.

FIG. 4A is a schematic illustrations of a fluid removal system according to a further embodiment of the present disclosure.

FIG. 4B is a detail of area 425 of FIG. 4A.

FIG. 4C is a detail of area 450 of FIG. 4A.

FIG. 4D is a detail of area 475 of FIG. 4A.

FIGS. 5A and 5B combine to form a schematic illustration of a fluid removal system according to a further embodiment of the present disclosure.

FIG. 5C is a detail of area 525 of FIG. 5A

FIG. 5D is a side view of an exemplary sample well.

FIGS. 6A-6B combine to illustrate a circuit diagram of an alternating pump control circuit according to an embodiment of the present disclosure.

FIG. 6C is a block diagram of exemplary pump power circuits.

FIG. 6D is a block diagram of an exemplary remote alarm signal circuit.

FIG. 7 is an elevation view of a separator tube according to an embodiment of the present disclosure.

FIG. 8 is a perspective view of another embodiment of a fluid removal system.

FIG. 9 contains perspective views of additional embodiments of fluid removal systems.

FIGS. 10-12 show details of some configuration embodiments for an embodiment of the present disclosure.

### DETAILED DESCRIPTION

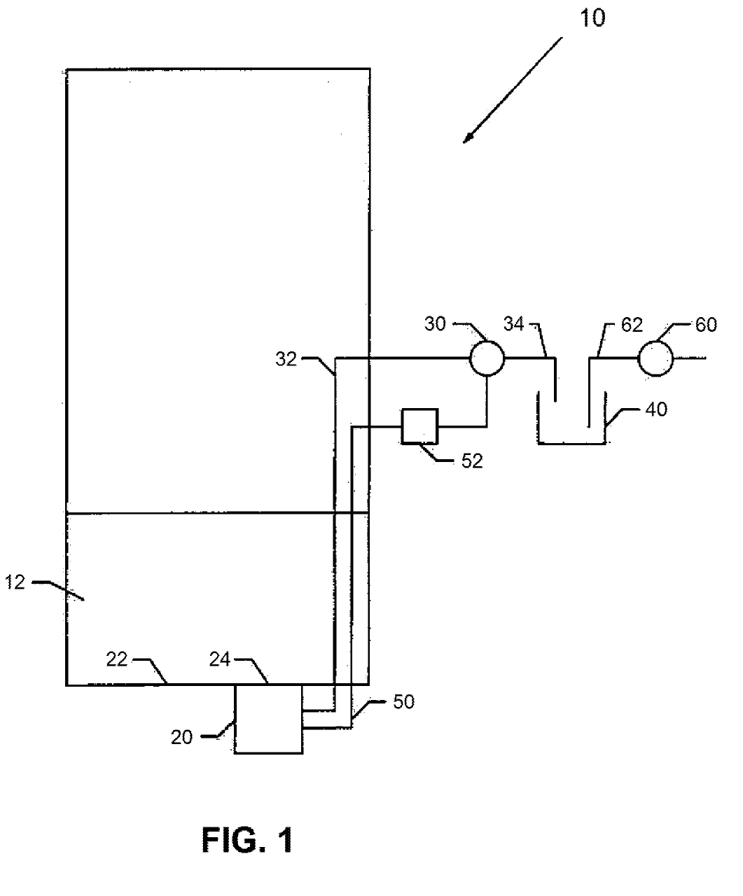

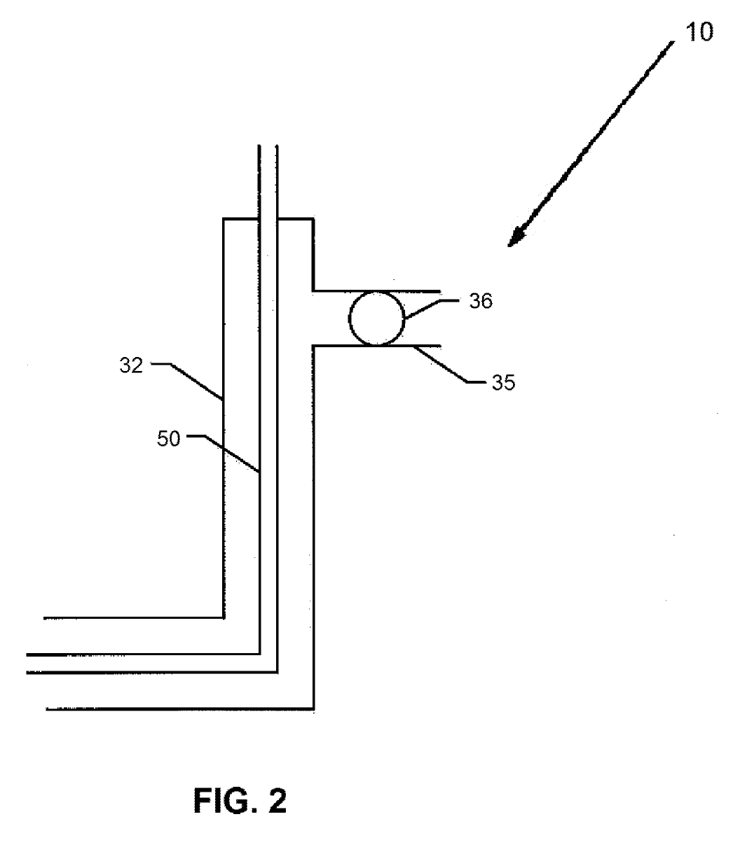

An embodiment of the invention is directed to a fluid removal system, as illustrated at 10 in the Figures, modified by the new embodiments described below under the heading “new embodiments” A discussion of general fluid removal systems follows, but new embodiments under the heading “new embodiments” are amenable to use with the general removal systems illustrated in FIGS. 1-2. While the fluid removal system is particularly suited for use in conjunction with an elevator pit 12, the fluid removal system 10 may be adapted for other applications in which water must be removed.

The water removal system 10 includes a collection container 20 (in one embodiment a sump basket) that is installed in a lower surface 22 of a pit 12 (in one embodiment, an elevator pit). The collection container 20 is fabricated with a size that is adapted to receive the water that flows into the collection container 20 without overflowing. The larger the width and depth of the collection container 20, the more water that can accumulate in the collection container 20. While a collection container is described generally, it should be understood that the term container encompasses natural containers or other enclosures such as baskets, buckets, holes, lined low-level areas, concrete or metal containers, and the like, without departing from the scope of the disclosure.

In one configuration, the collection container 20 has a cylindrical shape with a width and a height that are each between about 12 and 36 inches. In another configuration, the width and the height of the collection container 20 are each between about 20 and 30 inches.

The collection container 20 may be fabricated from a variety of materials such as plastic or concrete. Additionally, the collection container 20 may be pre-fabricated or formed on site. To increase the safety of the elevator pit 12 and prevent objects from inadvertently entering the collection container 20, a sump lid 24 may be placed over the collection container 20.

While the sump lid 24 substantially covers the collection container 20, the sump lid 24 may permit water on the lower surface 22 of the elevator pit 12 to drain into the collection container 20. Drain tile from walls and/or floors may be tied into the collection container 20.

The water removal system 10 also includes a pump assembly 30 that is located outside of but in proximity to the elevator pit 12. The size and capacity of the pump assembly 30 may be selected based upon a variety of factors such as a height the fluid must be lifted for discharge, the run over which the water must be pumped to reach the discharge and the volume of fluid that must be removed from the collection container 20. In one configuration, the pump assembly is a shallow well style pump.

The pump assembly 30 is operably connected to the collection container 20 with a pump inlet tube 32. The size and material from which the pump inlet tube 32 is fabricated are selected based upon the volume of fluid that must be removed from the stump basket 20. In one configuration, the pump inlet tube 32 has a diameter of about one inch and is fabricated from copper.

Depending on the size of the elevator pit 12, the pump inlet tube 32 may be mounted on the surface of the wall or floor of the elevator pit 12. Alternatively, the pump inlet tube 32 may be mounted behind the wall or floor of the elevator pit 12.

A pump outlet tube 34 is attached to the pump assembly. Fluid pumped out of the collection container 20 using the pump assembly 30 may be directly discharged. Alternatively, depending on the composition of the fluid pumped out of the collection container 20, the fluid may need to be treated prior to discharge.

In certain embodiments, if the fluid contains contaminants such as oil that exceed applicable building or environmental codes, a separator sump 40 may be utilized to collect the fluid from the pump outlet tube 34 and then separate the contaminants from the fluid such as through settling.

In such a configuration, a separator pump 60 may be utilized to discharge fluid from the separator sump 40 using a separator sump outlet tube 62. The separator pump 60 may have a variety of configurations such as being at least partially submersed in the separator sump 40. Alternatively, it is possible for the fluid removal system 10 to utilize a trap to prevent the escape of sewer gas.

In many applications, it will not be necessary or desirable for the pump assembly 30 to run continuously. Operation of the pump assembly 30 may be controlled by a fluid level sensor that monitors the fluid level in the collection container 20.

In one configuration, the fluid level sensor utilizes a pressure sensor tube 50 that extends from the sump 40 to a pressure switch 52. As the level of fluid in the collection container 20 exceeds a specified level, the fluid pressure inside the end of the pressure sensor tube 50 inside the collection container 20 raises and such pressure increase is transmitted to the pressure switch 52, which controls the operation of the pump assembly 30.

The size and material from which the pressure sensor tube 50 is fabricated are selected based upon the pressure sensitivity and the length of the pressure sensor tube 50. In one configuration, the pressure sensor tube 50 has a diameter of about one half of an inch and is fabricated from copper.

Depending on the size of the elevator pit 12, the pressure sensor tube 50 may be mounted on the surface of the wall or floor of the elevator pit 12. Alternatively, the pressure sensor tube 50 may be mounted behind the wall or floor of the elevator pit 12.

Because of the location of the pump inlet tube 32 and the pressure sensor tube 50 in the elevator pit 12, it may be difficult to inspect these tubes. It may also be difficult to access the components of the fluid removal system 10 to ensure that they are operating correctly. To enable the evaluation operation of the fluid removal system 10, the pump inlet tube 32 and/or the pressure sensor tube 50 may have a valve that may be used for introducing fluid into the collection container 20 for testing the operation of the fluid removal system 10.

As an alternative to separately mounting the pump inlet tube 32 and the pressure sensor tube 50 in the elevator pit 12, it is possible to mount one of the tubes inside of the other tube for a portion of the length, as illustrated in FIG. 2. In one configuration, the pressure sensor tube 50 may be mounted inside of the pump inlet tube 32, as the pressure sensor tube 50 is generally smaller than the pump inlet tube 32.

As an alternative to configuring the fluid level sensor to operate using a hydraulic mechanism, it is possible to operate the fluid level sensor using other mechanisms. Examples of such alternative mechanisms for the fluid level sensor include pneumatic and optical. The pneumatic system could operate using a mechanism that is similar to the mechanism discussed above with respect to the hydraulic system.

An optical system could include a light source and a light sensor. The light source may be mounted outside of the elevator pit 12 to comply with building codes. The light can be directed from the light source to the light sensor using optical fibers. The presence of fluid interrupts the path of light between the light source and the light sensor such that it can be determined when the fluid level has reached a point where the pump 30 should be activated.

The fluid level sensor may include a high fluid alarm and a low fluid alarm such that the pump 30 is activated when the fluid level is higher than the high fluid alarm and deactivated when the fluid level is lower than the low fluid alarm. Alternatively, the pump 30 can be activated when the fluid level is higher than the high fluid alarm and then deactivated after a selected period of time.

The fluid level sensor thereby enables the fluid to be removed from the collection container 20 without the use of mechanical devices placed inside of the collection container 20. The fluid removal system 10 thereby protects the components of the elevator that are located within the elevator pit 12 while complying with the applicable building codes.

In another configuration, the fluid level sensor utilizes a float (not shown) mounted in the collection container 20. Once the float rises above a specified level, the pump assembly 30 is activated.

In conjunction with the fluid removal system 10, additional components may be utilized to protect the components of the elevator from damage caused by fluid accumulating in the elevator pit 12. Such additional components include applying a waterproof sealant to the walls and floor of the elevator pit 12. Another additional component is a drain tile system placed along the intersection of the walls and floor of the elevator pit 12. One such drain tile system is available under the trademark BEAVER.

Control panels for a fluid removal system according to embodiments of the present disclosure may be mechanical or electronic. For example, a series of relays, switches, sensors, and the like may be used in a mechanical panel to initiate or discontinue operation of the pump of the system, to test operation of the system, to trigger an alarm such as for a high fluid alarm or a low fluid alarm, or the like. Mechanical panels are known in the art, and have been utilized with systems such as fluid removal system 10 for some time.

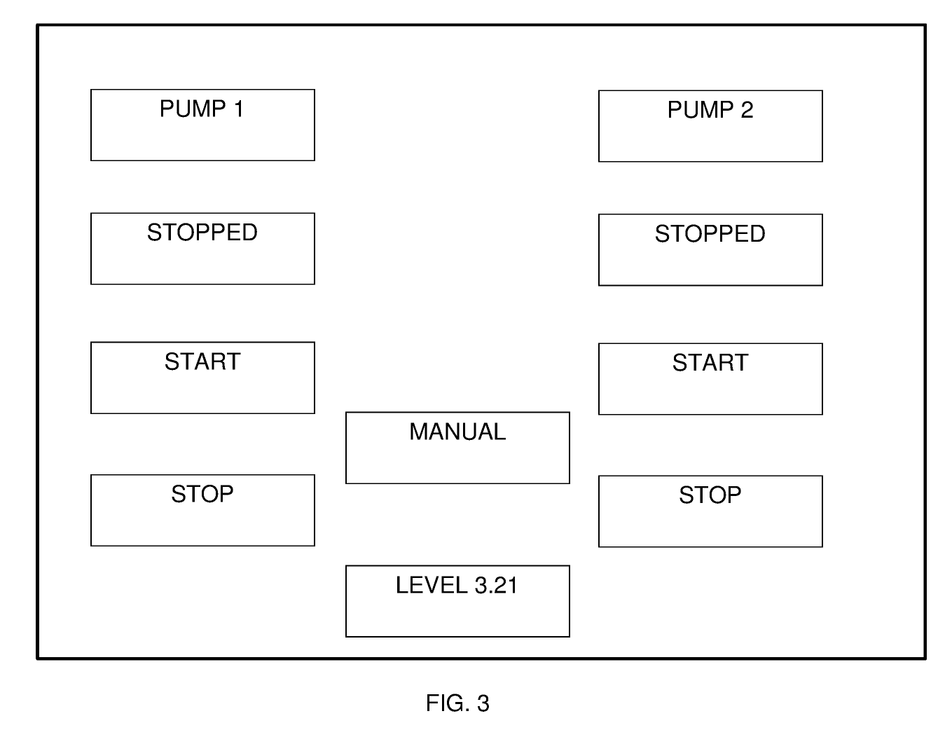

In another embodiment, an electronic panel is used. A view of a representative electronic panel is shown for informational purpose in FIG. 3. Such an electronic panel may contain a controller such as a programmable logic unit, processor, or the like, that is capable of connection to, and monitoring of operation of, a fluid removal system such as system 10, while additionally being operably connectable, such as through a wired or wireless connection, to a building alarm system of the like. By way of example only and not by way of limitation, the controller may couple to external communication systems or the like, using analog, digital, thermocouple, or a combination of connections and modules for digital and/or analog input/output devices. The electronic panel may be configured in one embodiment to monitor system performance, initiate or discontinue operation, monitor fluid level sensors, perform test operations, purge air and/or fluid lines and fluid induction lines, and/or determine and report alarm or other conditions.

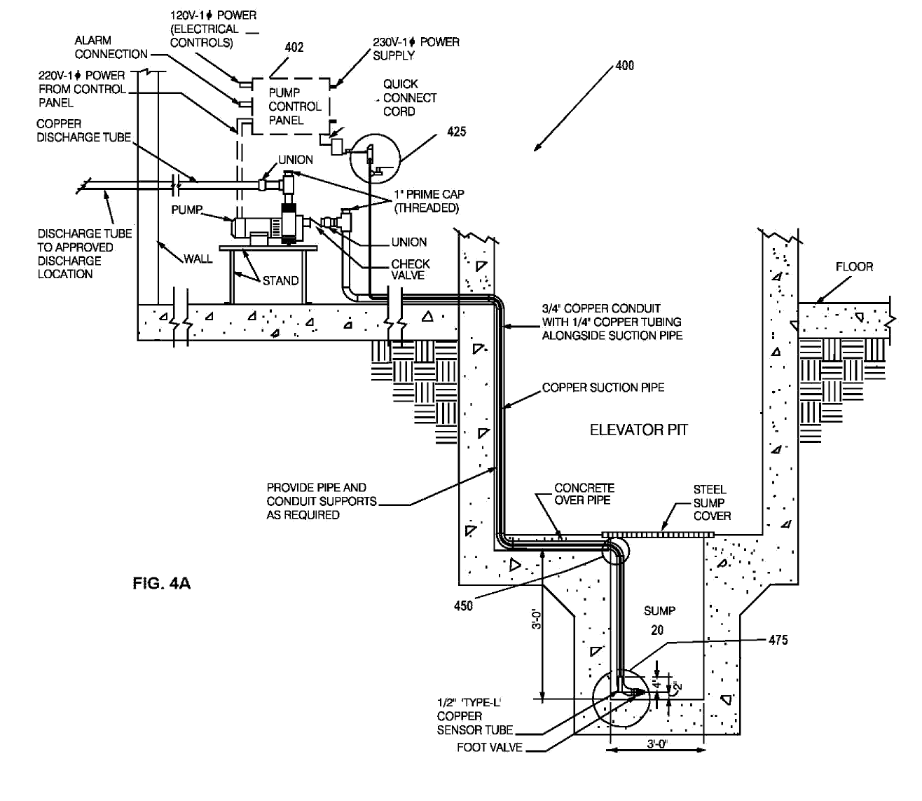

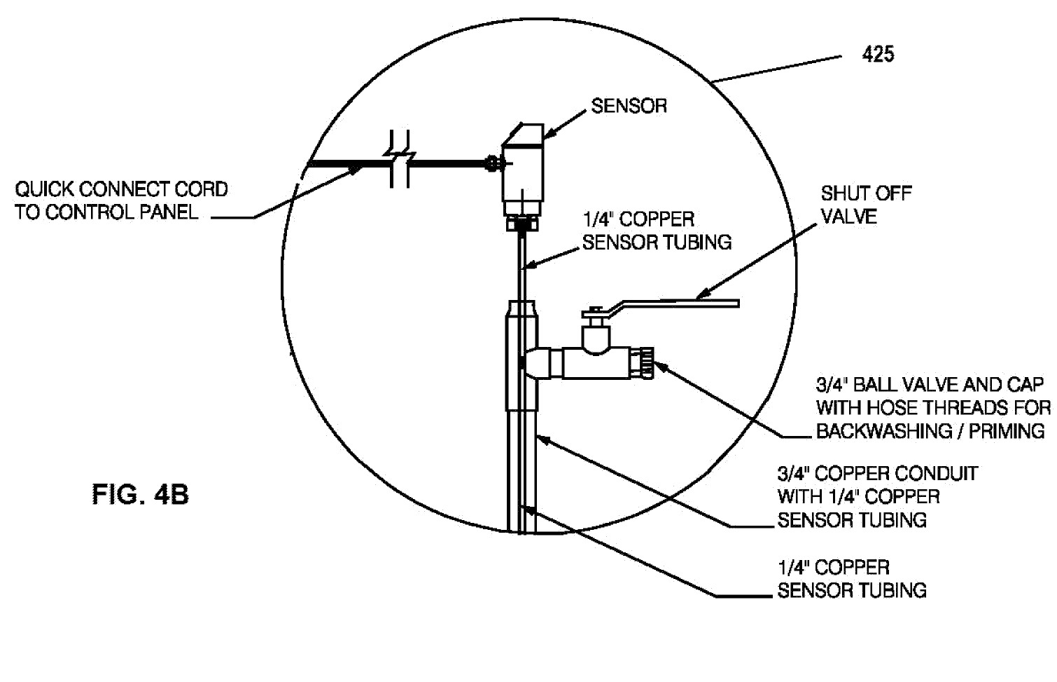

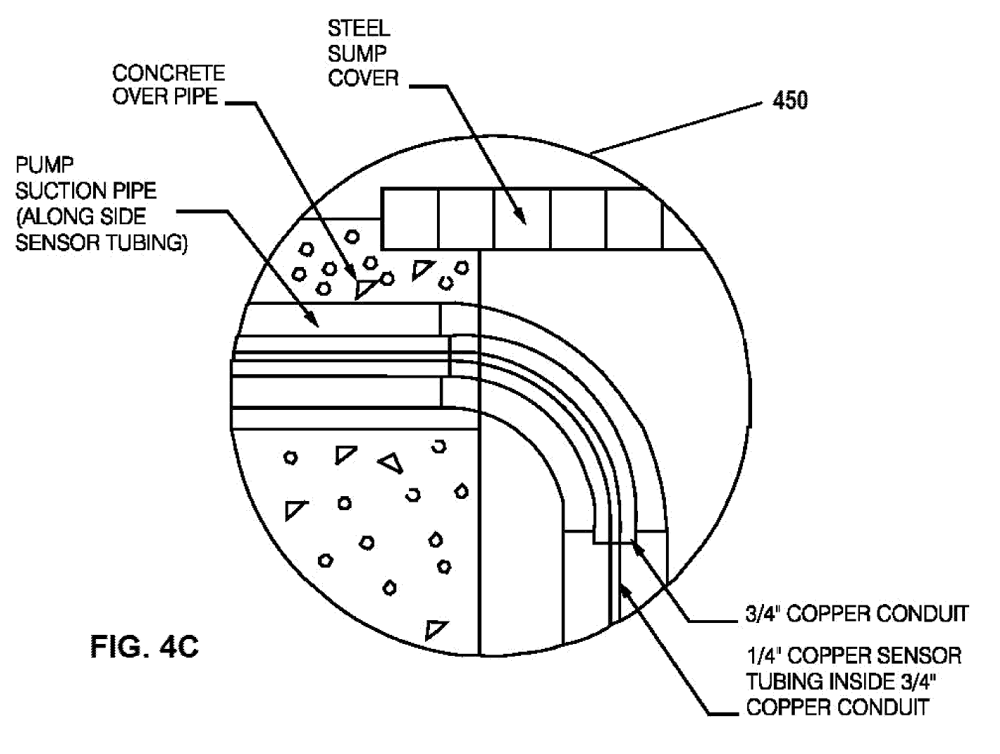

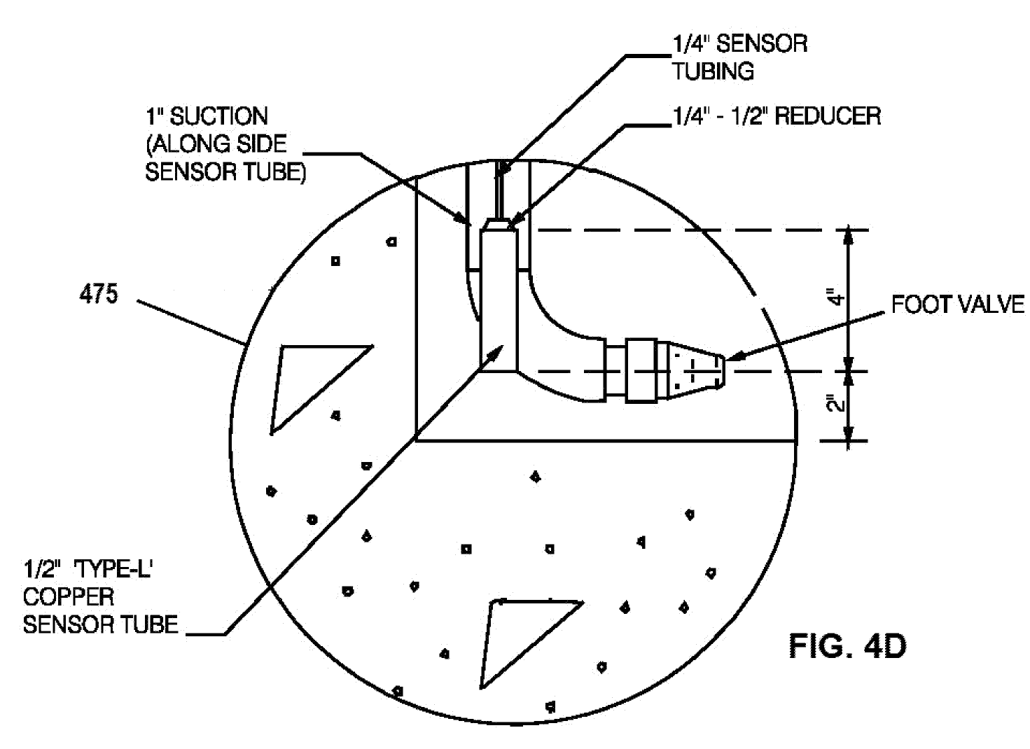

Further embodiments of systems include the system 400 shown in FIGS. 4A-4D, which includes by way of example only and not by way of limitation an electronic panel 402 such as that discussed above, which includes a controller. A control panel such as panel 402 may be used in various embodiments to control operation of a fluid removal system such as those shown in FIGS. 1-2, as well as additional fluid removal systems such as system 400, that operate to remove fluid from a collection container such as a sump or other collection container. The details of such a system 400 are variable, and are not described further herein, but the electronic panel 402 is amenable to use with a variety of systems without departing from the scope of the disclosure. Details of elements 425, 450, and 475 are shown further in FIGS. 4B, 4C, and 4D, respectively.

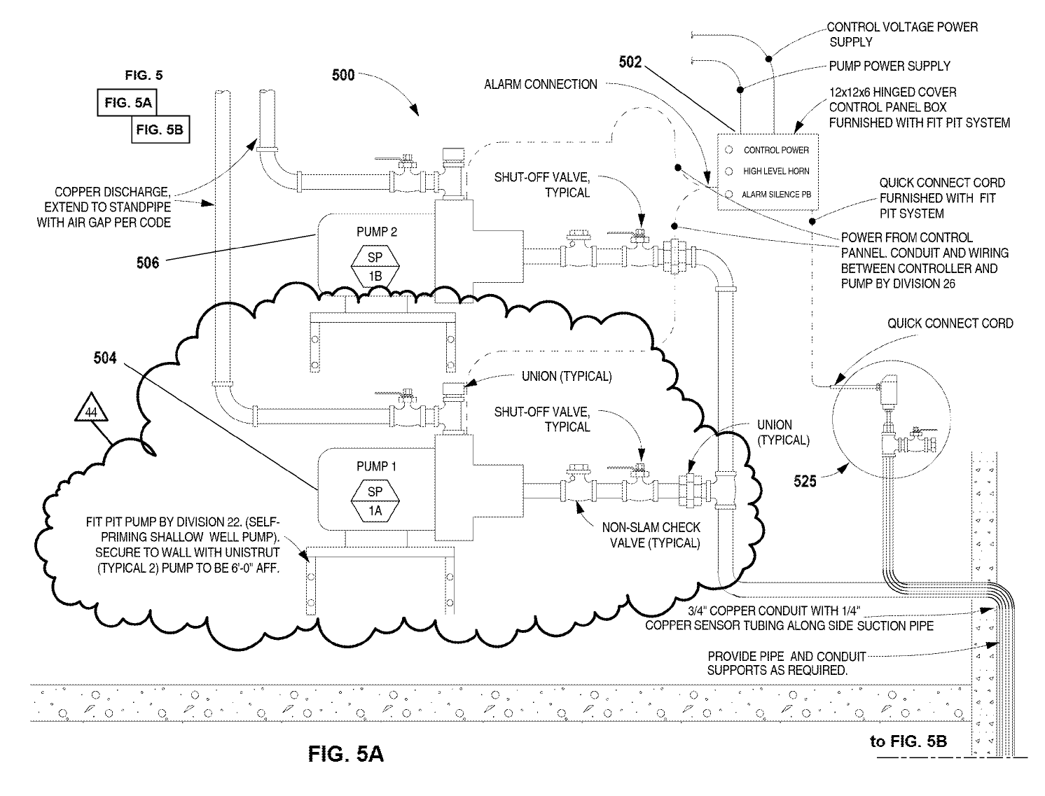

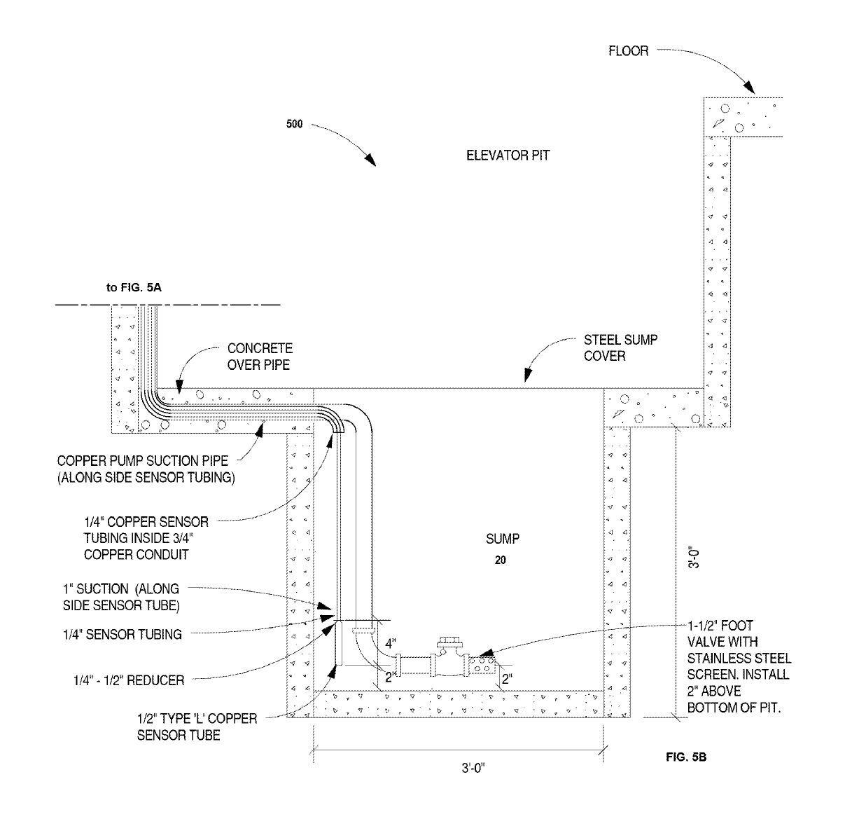

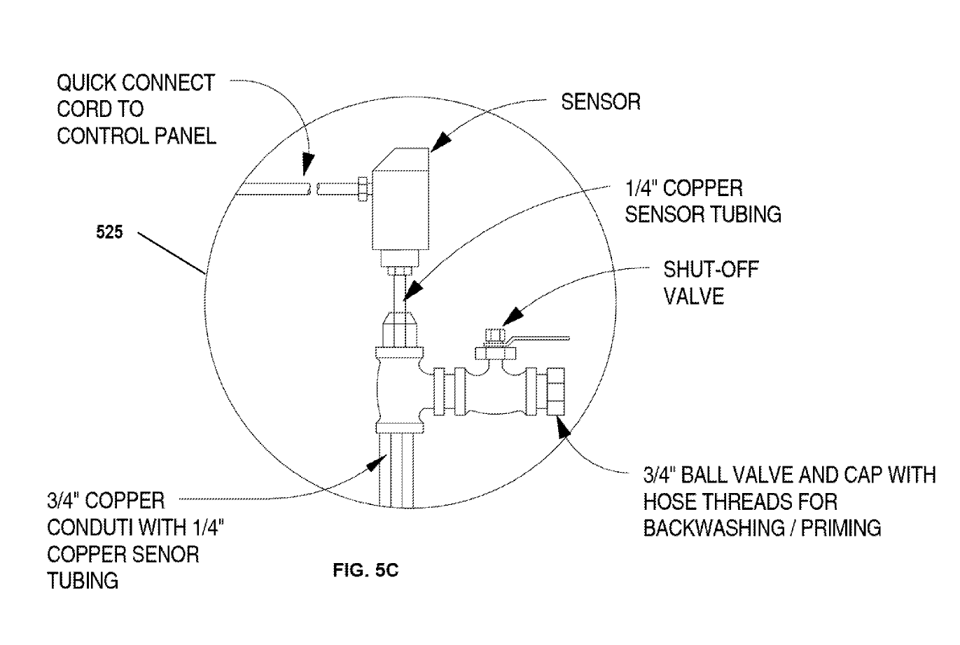

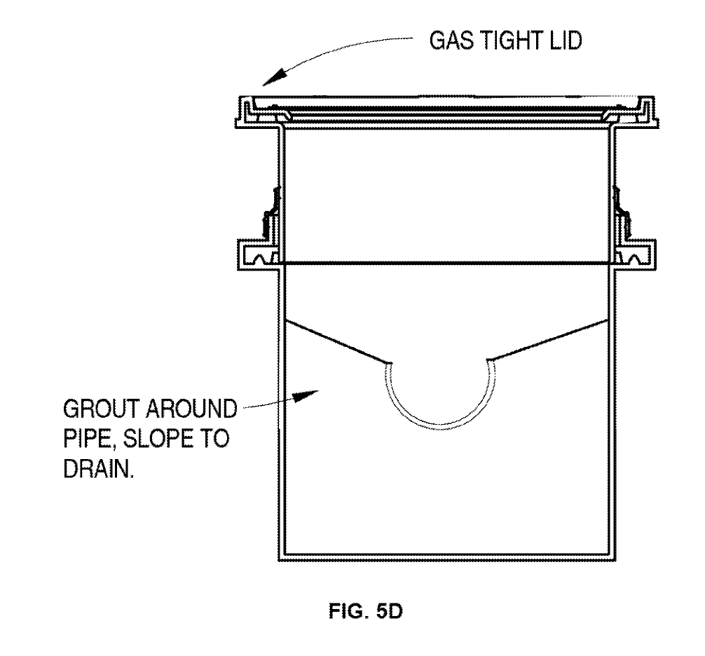

Still further embodiments of systems include the system 500 shown in FIGS. 5A-5B, which include by way of example only and not by way of limitation a control panel 502 for the control of multiple pumps such as pumps 504 and 506. Multiple pumps are used in one embodiment in an alternating or a duplex pattern of operation. Details of element 525 are shown further in FIG. 5C. An exemplary sample well is shown in FIG. 5D.

While two pumps 504 and 506 are shown in component FIGS. 5A-5B, it should be understood that more pumps may be used and controlled by a controller such as those described herein without departing from the scope of the disclosure. Further, operation of the pumps 504 and 506 may be controlled by the controller to allow for operation of one pump 504 or 506 at a time, or multiple pumps 504 and 506 at a time. This is useful especially given the ever-changing regulations regarding amount of water or fluid that a system such as systems 10, 400, or 500 must be capable of removing from a sump or pit 20, such as an elevator pit. The use of multiple pumps allows for wear leveling usage of pumps so that if a pump has been running for a particular period of time, operation may be switched to a different pump, or pumps, to allow for the overused pump to be rested, repaired, replaced, or the like, without shutting down the system. Pumps may be operated in combination, in round-robin, or in any programmable configuration using the controller of the present disclosure.

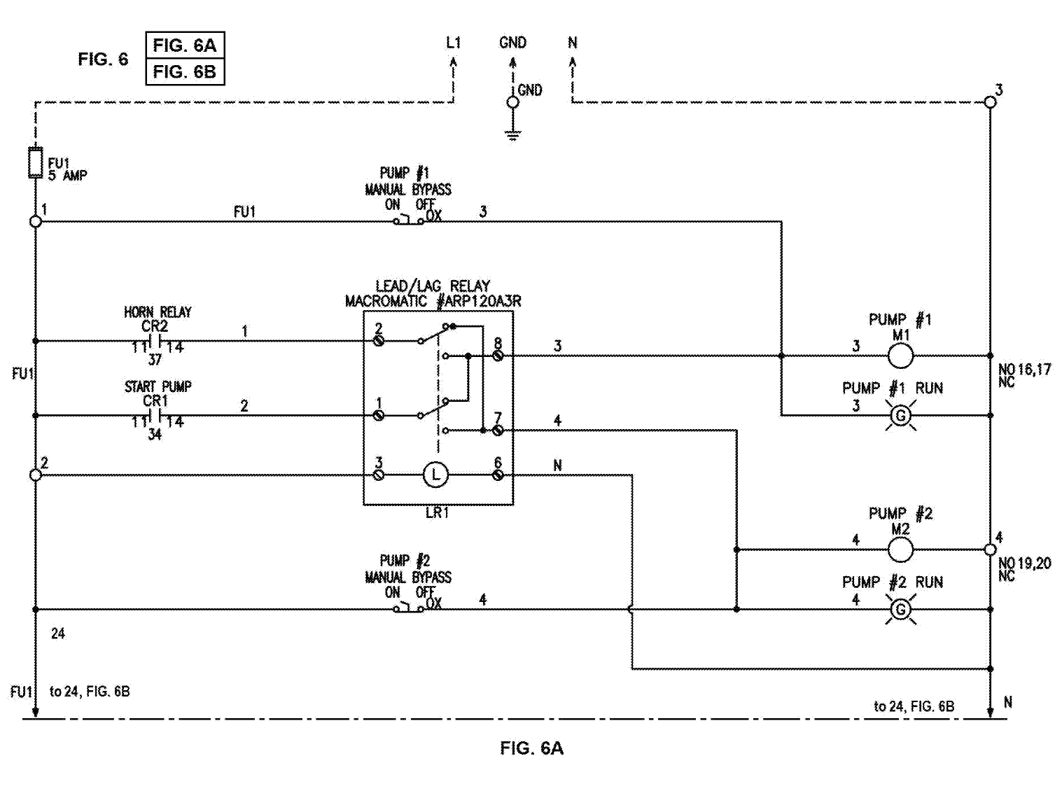

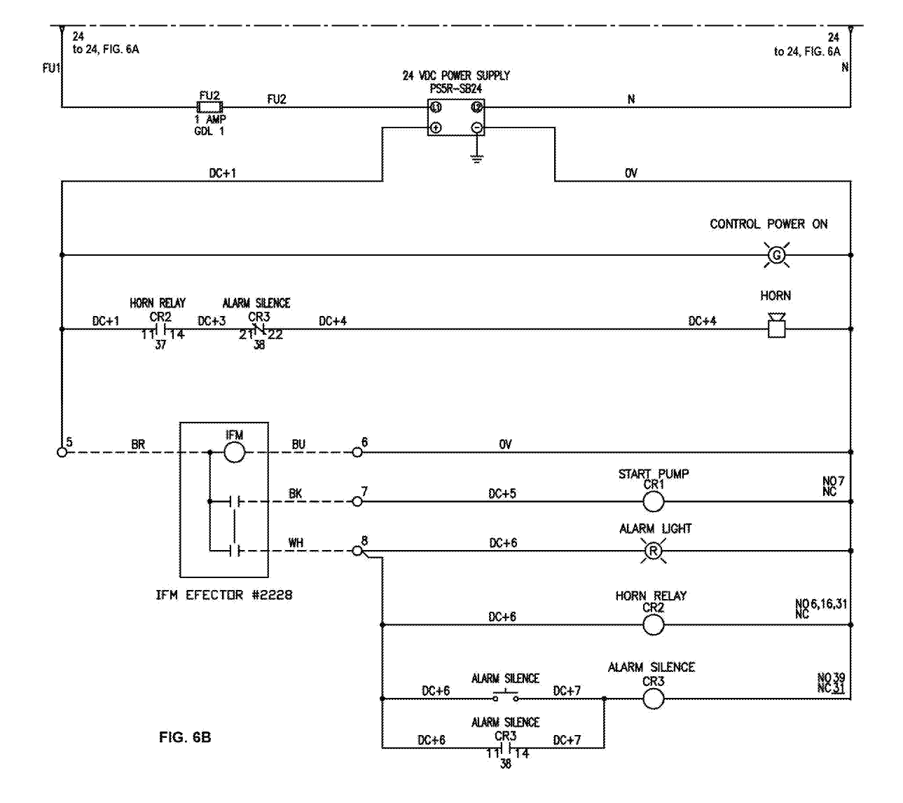

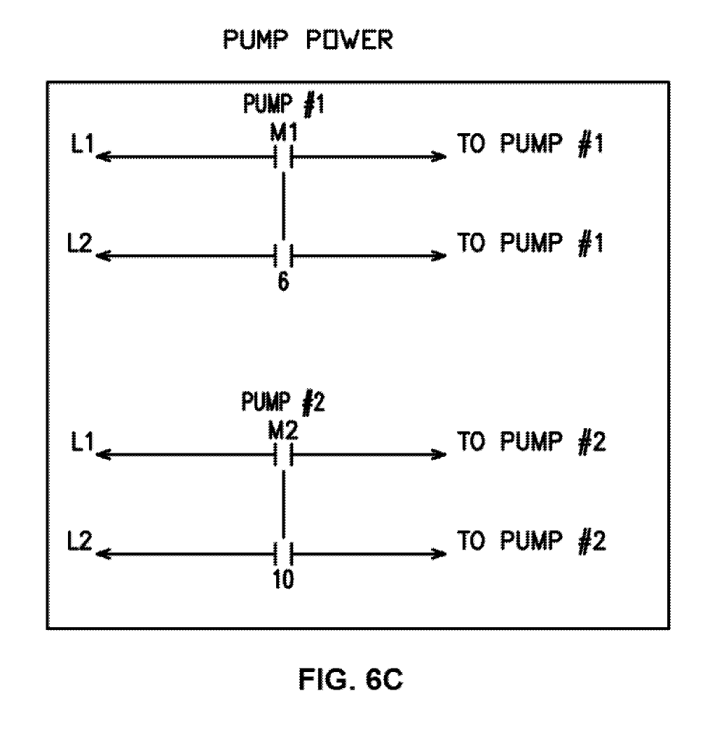

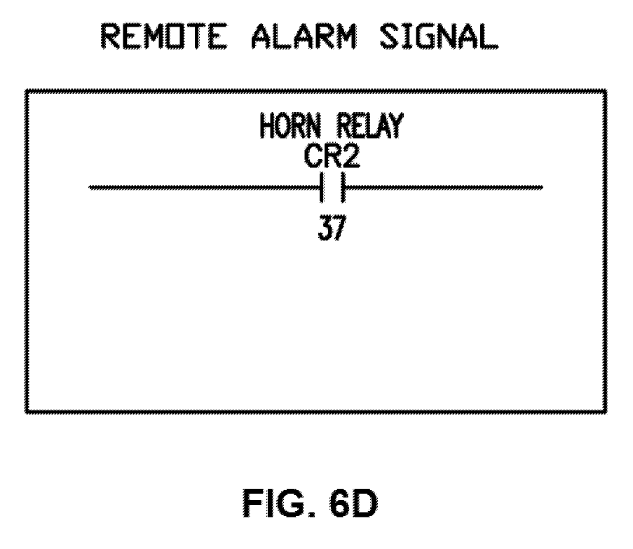

A circuit diagram for one embodiment of connection of a controller to components of the fluid removal system and external components is shown in schematic form in FIGS. 6A-6B. It should be understood that the circuit diagram is only one possible diagram for operation of the control panel and associated pump and system functions, and that one of skill in the art could easily envision and design different circuitry to perform the same function, which is within the scope of the disclosure. FIG. 6C is a block diagram of exemplary pump power circuits. FIG. 6D is a block diagram of an exemplary remote alarm signal circuit.

Typically, ground water enters a pit in a different manner than other fluids, for example sprinkled water, runoff fluid, contaminated fluids, and the like, which in one embodiment are fluids that enter a pit for example from a commercial sprinkler system such as a fire suppression system or the like, such as runoff from a tank or other fluid container. Ground water typically enters a prepared pit through channels that are hidden from and physically separated from the elevator pit, such as by the methods and systems described elsewhere herein. As such, water that accumulates within a pit, not a collection container, is typically sprinkled water.

An increasing concern in fluid removal systems is removal of such sprinkled fluid from a pit, and doing so separate from ground water removal. Reasons for this separation include but are not limited to potential contamination of sprinkled fluid by any number of biological and physical contaminants. As such, some codes now require that sprinkled fluid not only be removed from locations including pits such as an elevator pit, but that such removal be through a sanitary sewer system, as opposed to removal to a storm sewer system such as is typically used for removal of ground water.

In a system such as fluid removal system 10 described herein, ground water typically enters the pit and the collection container for the pit in such a way as to be contained within the collection container, whereas sprinkled fluid typically arrives in an elevator pit through the shaft and elevator door openings, and the like, as it drains from higher levels of a structure in which the elevator is used, or from a higher elevation than the collection container.

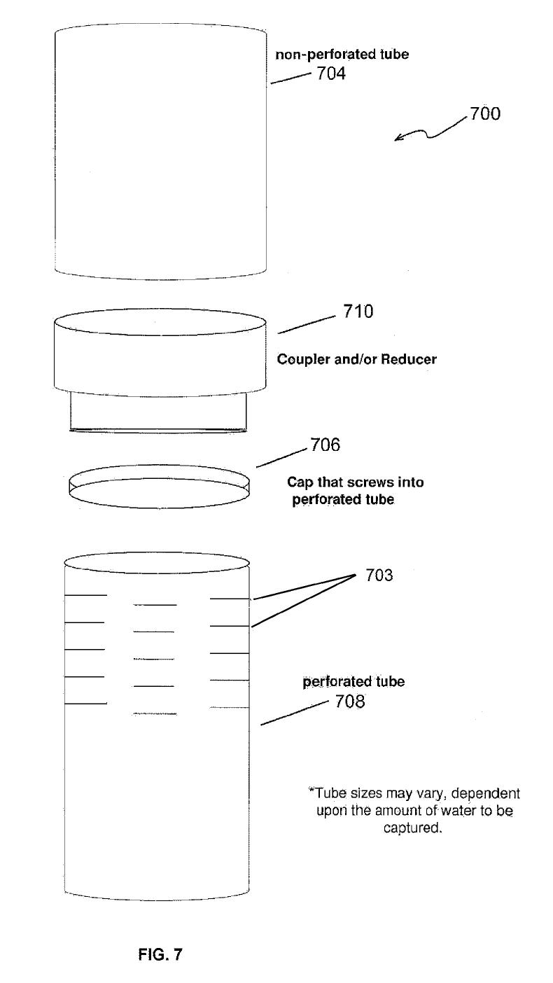

Referring to FIG. 7, one embodiment of a separator 700 for allowing separation of ground water and sprinkled fluid is shown. The separator in one embodiment is for separating ground water from sprinkled fluid in a collection location. Separator 700 comprises in one embodiment a perforated tube section 708 with perforations 703 for accepting ground water into an interior of the tube section 708. Tube section 708 in one embodiment lines a pit, for example as an embodiment of a collection container such as container or sump 20 described herein. The tube section 708 is capped in this embodiment by cap 706 at a level above that where ground water enters the section 708. The cap is water-tight in one embodiment. Above the cap 706, in this embodiment, a non-perforated tube section 704 is positioned to collect sprinkled fluid.

In one embodiment, this non-perforated tube is configured to gather fluid that results from sprinkling, for example fluid that drains into the pit through the elevator shaft or the like, or generally from a higher elevation location to a lower collection container location. In one embodiment, the non-perforated section 704 also rests at least partially within a lower pit or sump below grade of the collection container bottom, but the non-perforated section accepts only fluid that enters the pit not via the drain tiles or other ground water channels. In this embodiment separate pumps may be connected to evacuate fluid from the sections 708 and 704, with fluid from section 708 evacuated as ground water, and with fluid from section 704 evacuated as sprinkled fluid. In another embodiment, a single pump and pipe may be used for the evacuation of fluid, provided that appropriate valves, for example a check valve or valves, are provided in the pipe to prevent the mixing of fluid from the separate sections 708 and 704. A coupler/reducer 710 is shown. Coupler/reducer 710 allows perforated and non-perforated tubes of different sizes to be connected in one stack. It should be understood that the dimensions of the tubes 704 and 708 may be larger or smaller, and may be of different sizes, depending upon an amount of fluid to be removed, without departing from the scope of the disclosure.

In another embodiment, a sensor tube is positioned in the collection location, such as a collection container, a pit, or a sump, to monitor a fluid level in the pit or sump. For example, if a fluid level in the collection container, such as a pit or a sump, is at or below a level determined by the position of the sensor, and the fluid level remains at or below the level for a predetermined but programmable amount of time, then the sensor output triggers the control panel to open a solenoid to add water to the sump until the fluid level in the sump reaches the level determined by the position of the sensor. In this embodiment, then, the system can self-prime for a low fluid condition.

A method of separating ground water from sprinkled fluid in a collection location, such as in one embodiment an elevator pit, for removal with a fluid removal system, comprises gathering ground water in a perforated tube, the perforated tube positioned at or below a ground water level, gathering sprinkled fluid in a non-perforated tube, the non-perforated tube positioned above a ground water level, removing gathered ground water from the perforated tube to a first external location, and removing gathered sprinkled fluid from the non-perforated tube to a second external location.

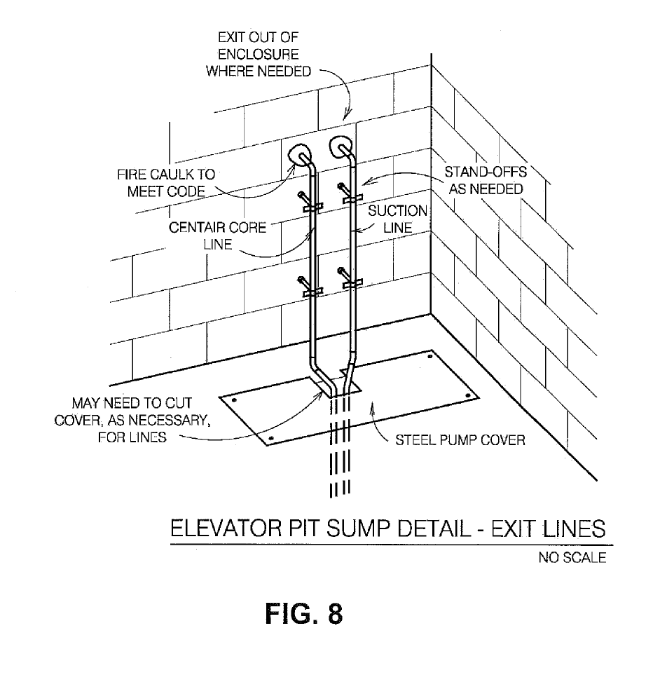

FIG. 8 shows another embodiment with elevator pit sump details.

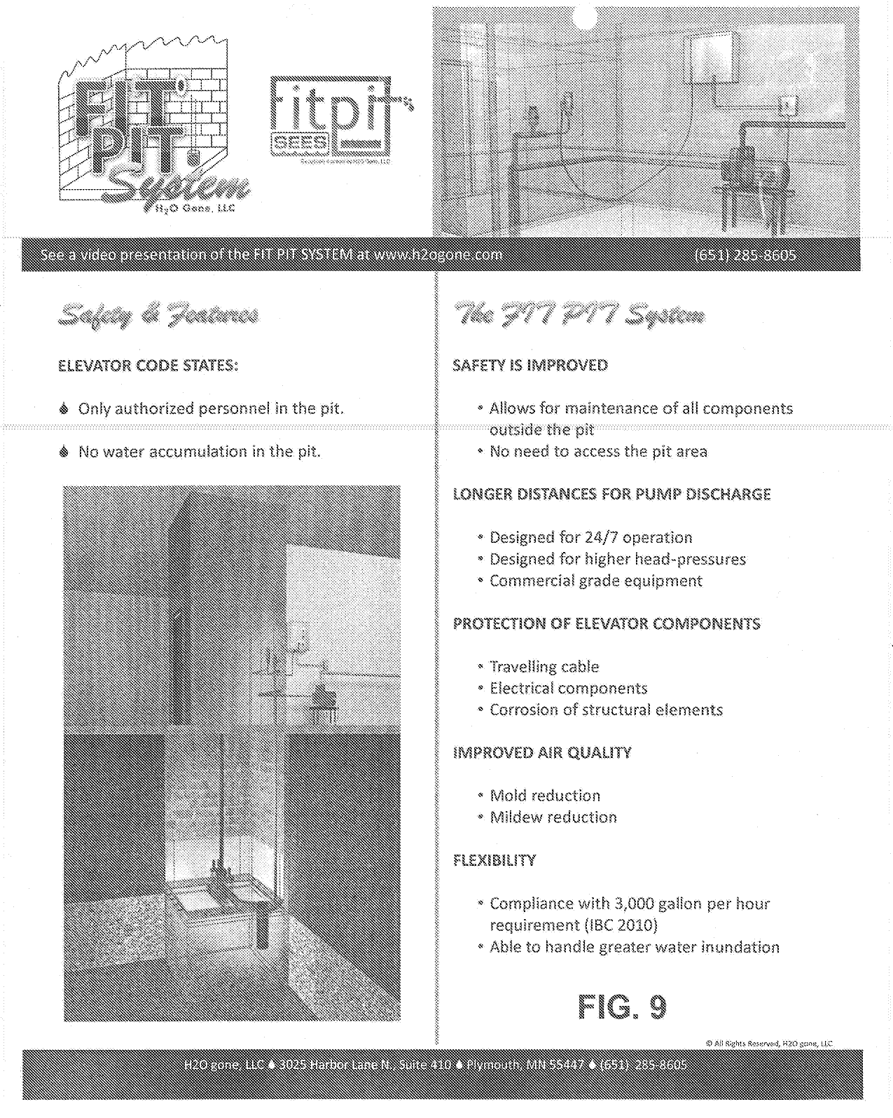

FIG. 9 shows another embodiment of a fluid removal system.

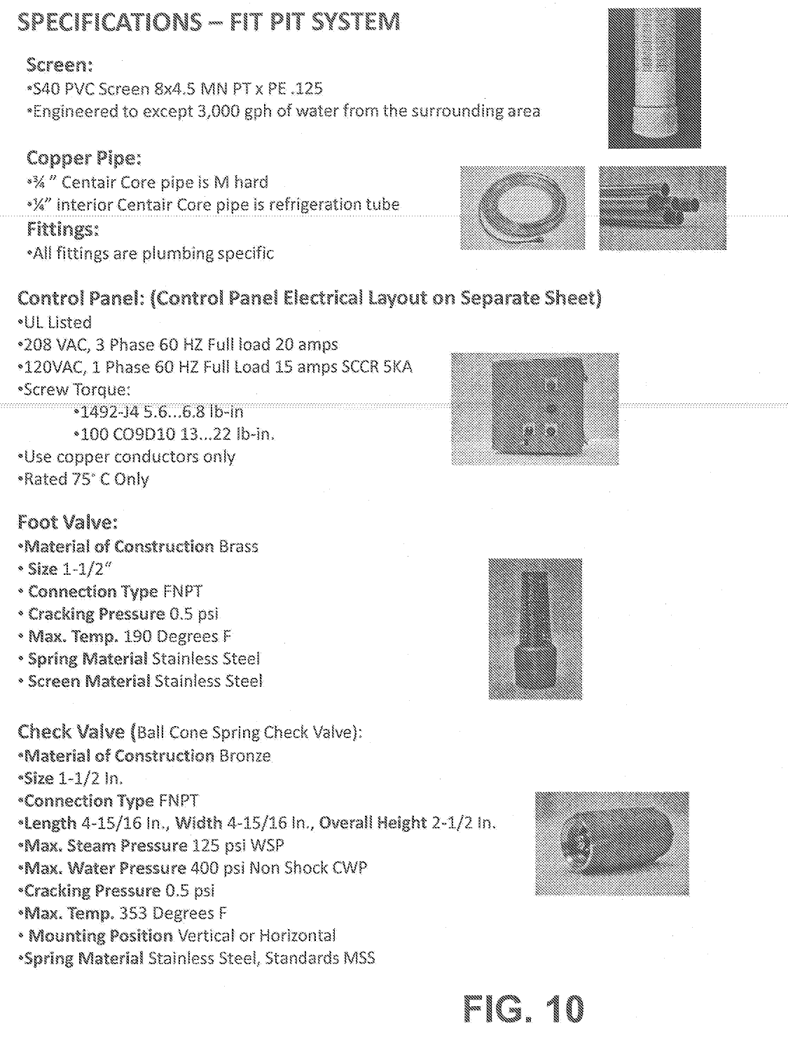

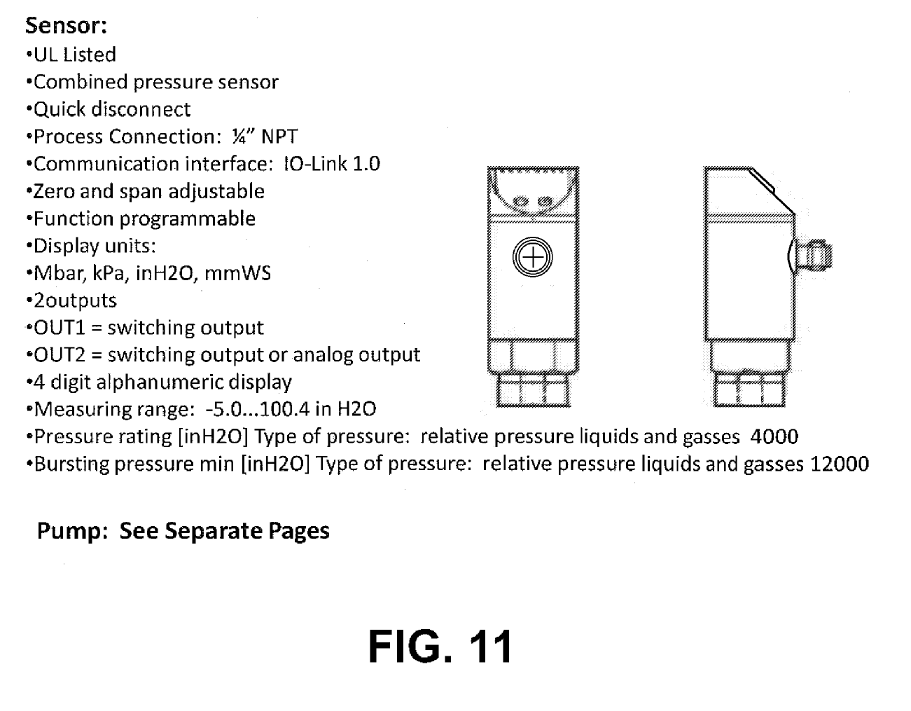

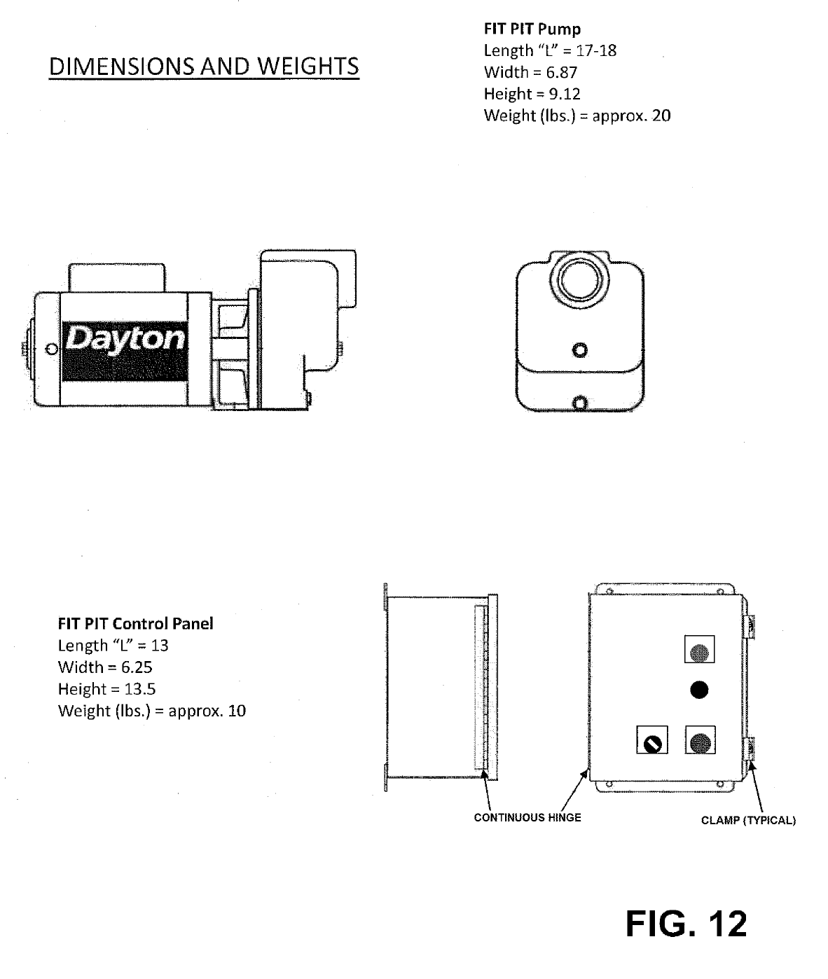

FIGS. 10-12 show details of some configuration embodiments for an embodiment of the present disclosure. It should be understood that while specific dimensions and products are shown, other products and other dimensions performing the functions of the structure and methods described herein may be readily substituted without departing from the scope of the disclosure.

It is contemplated that features disclosed in this application, as well as those described in the above applications incorporated by reference, can be mixed and matched to suit particular circumstances. Various other modifications and changes will be apparent to those of ordinary skill

What is claimed is:

1. A fluid removal system for removing fluid from a collection location, wherein the fluid removal system comprises:
a collection container that at least partially extends directly below a lower surface of the collection location;
a pump mounted outside of the collection location;
a pump input tube that is operably connected to the collection container and the pump;
a pump output tube that is operably connected to the pump; and
a switching mechanism mounted outside of the collection container, wherein the switching mechanism is operably connected to the pump and the collection container; and
a controller configured to control operation of the pump and the switching mechanism.

2. The fluid removal system of claim 1, wherein the switching mechanism further comprises a pressure sensor tube mounted concentrically within the pump input tube

3. The fluid removal system of claim 1, wherein the switching mechanism is pneumatically, hydraulically or optically operated.

4. The fluid removal system of claim 1, wherein the switching mechanism includes a sump fluid sensor.

5. The fluid removal system of claim 1, wherein the pump input tube is mounted to a surface of the elevator pit.

6. The fluid removal system of claim 1, and further comprising a separator sump operably connected to the pump output tube.

7. The fluid removal system of claim 5, and further comprising a separator sump pump to remove fluid from the separator sump.

8. The system of claim 1, wherein the pump input tube has a valve for introduction of fluid to the collection container.

9. The system of claim 1, wherein the switching mechanism operates by providing a pressure activatable switch, and extending the pressure sensor tube between the pressure activatable switch and the collection container.

10. The system of claim 1, wherein the fluid in the system comprises ground water and sprinkled fluid, and further comprising:
a separator for separating the ground water from the sprinkled fluid, the separator comprising:
a first tube for collecting the sprinkled fluid, the first tube being a solid-wall tube;
a second tube for collecting the ground water, the second tube having a perforated wall;
a cap connecting the first tube to the second tube, the cap further separating an interior of the first tube from an interior of the second tube;
wherein the first tube is positionable above ground water level to accumulate sprinkled fluid accumulating in the collection location, and the second tube is positionable at or below ground water level to accumulate ground water therein.

11. The fluid removal system of claim 1, wherein the collection container is a sump basket.

12. The fluid removal system of claim 1, wherein the collection location is an elevator pit.

13. A method of removing fluid from a collection location, wherein the method comprises:
providing a collection container that at least partially extends directly below a lower surface of the collection location; pumping fluid from the collection container with a pump; and
controlling the operation of the pump using a switching mechanism, wherein the pump and the switching mechanism are located outside of the collection location and wherein the switching mechanism activates when a level of fluid in the collection container exceeds a high fluid sensor, including providing a pressure activatable switch and extending a pressure sensor tube between the pressure activatable switch and the collection container, wherein the pressure sensor tube is mounted concentrically within a pump input tube.

14. The method of claim 13, wherein the switching mechanism is pneumatically, hydraulically or optically operated.

15. The method of claim 13, wherein the switching mechanism further comprises a low fluid sensor and wherein the switching mechanism causes the pump to deactivate when the fluid level falls below the low fluid sensor.

16. The method of claim 13, and further comprising collecting fluid from the pump in a separator container.

17. The method of claim 16, and further comprising pumping fluid from the separator container with a separator sump pump.

18. A method of separating ground water from sprinkled fluid in an elevator pit, for removal with a fluid removal system, the method comprising:
gathering ground water in a perforated tube, the perforated tube positioned at or below a ground water level;
gathering sprinkled fluid in a non-perforated tube, the non-perforated tube positioned above a ground water level;
removing gathered ground water from the perforated tube to a first external location; and
removing gathered sprinkled fluid from the non-perforated tube to a second external location.

19. The method of claim 18, wherein removing gathered ground water is performed with a first pump, and wherein removing gathered sprinkled fluid is performed with a second, separate pump.

20. The method of claim 18, wherein removing gathered ground water and gathered sprinkled fluid is performed with a single pump.

21. A separator for separating ground water from sprinkled fluid in a collection location, the separator comprising:
a first tube for collecting sprinkled fluid, the first tube being a solid-wall tube;
a second tube for collecting ground water, the second tube having a perforated wall;
a cap connecting the first tube to the second tube, the cap further separating an interior of the first tube from an interior of the second tube;
wherein the first tube is positionable above ground water level to accumulate sprinkled fluid accumulating in the collection location, and the second tube is positionable at or below ground water level to accumulate ground water therein.

22. The separator of claim 21, wherein the cap further comprises a coupler configured to couple together a first tube and a second tube having different sizes.
